(19) United States
(12) Patent Application Publication
(10) Pub. No.: US 2014/0200168 A1
(43) Pub. Date: Jul. 17, 2014

(54) TREATMENT FLUID CONTAINING A CORROSION INHIBITOR POLYMER OF A CARBOHYDRATE AND QUATERNARY AMINE

(71) Applicant: HALLIBURTON ENERGY SERVICES, INC., Houston, TX (US)

(72) Inventors: Garima MISRA, Pune (IN); Arunesh KUMAR, London (GB)

(73) Assignee: HALLIBURTON ENERGY SERVICES, INC., Houston, TX (US)

(21) Appl. No.: 13/739,272

(22) Filed: Jan. 11, 2013

(51) Int. Cl. C09K 8/54

(52) U.S. Cl. CPC C09K 8/54
USPC 507/110; 507/209; 507/214

(57) ABSTRACT

A treatment fluid comprises: water; a carboxylate; and a corrosion inhibitor, wherein the corrosion inhibitor is environmentally-friendly, biodegradable, and is a polymer, wherein the polymer comprises a carbohydrate backbone and a quaternary amine functional group; wherein a test fluid consisting essentially of the water, the carboxylate, and the corrosion inhibitor, and in the same proportions as in the treatment fluid, is capable of providing a corrosion weight loss to a metal plate of less than 0.05 pounds per square feet (lb/ft²) under testing conditions of 200° F. (93.3° C.), a pressure of 500 psi (3.4 MPa), and a time of 24 hours whereas a substantially identical test fluid without the corrosion inhibitor provides a corrosion weight loss of greater than 0.05 lb/ft² under the testing conditions. A method of treating a portion of a well comprises: forming the treatment fluid; and introducing the treatment fluid into the well.

### TECHNICAL FIELD

A treatment fluid and methods of use are provided. The treatment fluids include a corrosion inhibitor of a polymer having a carbohydrate backbone and a quaternary amine. The polymer is environmentally-friendly and biodegradable. The treatment fluid can also include a corrosion inhibitor intensifier. The treatment fluid can include a delayed acid breaker system for removing a filtercake from a wellbore.

### SUMMARY

According to an embodiment, a method of treating a portion of a well comprises: forming a treatment fluid, wherein the treatment fluid comprises: (A) water; (B) a carboxylate; and (C) a corrosion inhibitor, wherein the corrosion inhibitor is environmentally-friendly, biodegradable, and is a polymer, wherein the polymer comprises a carbohydrate backbone and a quaternary amine functional group; wherein a test fluid consisting essentially of the water, the carboxylate, and the corrosion inhibitor, and in the same proportions as in the treatment fluid, is capable of providing a corrosion weight loss to a metal plate of less than 0.05 pounds per square feet (lb/ft²) under testing conditions of 200° F. (93.3° C.), a pressure of 500 psi (3.4 MPa), and a time of 24 hours whereas a substantially identical test fluid without the corrosion inhibitor provides a corrosion weight loss of greater than 0.05 lb/ft² under the testing conditions; and introducing the treatment fluid into the well.

According to another embodiment, a method of treating a portion of a well comprises: forming a treatment fluid, wherein the treatment fluid comprises: (A) water; (B) a carboxylate, wherein the carboxylate is capable of forming a carboxylic acid in the presence of the water; and (C) a corrosion inhibitor, wherein the corrosion inhibitor: (i) is environmentally-friendly and biodegradable; and (ii) is a polymer, wherein the polymer comprises a carbohydrate backbone and a quaternary amine functional group; and introducing the treatment fluid into the well.

According to another embodiment, a treatment fluid comprises: water; a carboxylate; and a corrosion inhibitor, wherein the corrosion inhibitor is environmentally-friendly, biodegradable, and is a polymer, wherein the polymer comprises a carbohydrate backbone and a quaternary amine functional group; wherein a test fluid consisting essentially of the water, the carboxylate, and the corrosion inhibitor, and in the same proportions as in the treatment fluid, is capable of providing a corrosion weight loss to a metal plate of less than 0.05 pounds per square feet (lb/ft²) under testing conditions of 200° F. (93.3° C.), a pressure of 500 psi (3.4 MPa), and a time of 24 hours whereas a substantially identical test fluid without the corrosion inhibitor provides a corrosion weight loss of greater than 0.05 lb/ft² under the testing conditions.

### DETAILED DESCRIPTION OF THE INVENTION

As used herein, the words “comprise,” “have,” “include,” and all grammatical variations thereof are each intended to have an open, non-limiting meaning that does not exclude additional elements or steps.

As used herein, the words “consisting essentially of,” and all grammatical variations thereof are intended to limit the scope of a claim to the specified materials or steps and those that do not materially affect the basic and novel characteristic(s) of the claimed invention. For example, the test fluid consists essentially of: the water; the carboxylate; and the corrosion inhibitor, and in the same proportions as in the treatment fluid. The test fluid can contain other ingredients so long as the presence of the other ingredients do not materially affect the basic and novel characteristics of the claimed invention, i.e., so long as the corrosion inhibitor is capable of providing corrosion weight loss of less than 0.05 pounds per square feet (lb/ft²) under testing conditions of 200° F. (93.3° C.), a pressure of 500 psi (3.4 MPa), and a time of 24 hours.

It should also be understood that, as used herein, “first,” “second,” and “third,” are arbitrarily assigned and are merely intended to differentiate between two or more monomers, etc., as the case may be, and does not indicate any sequence. Furthermore, it is to be understood that the mere use of the word “first” does not require that there be any “second,” and the mere use of the word “second” does not require that there be any “third,” etc.

As used herein, a “fluid” is a substance having a continuous phase that tends to flow and to conform to the outline of its container when the substance is tested at a temperature of 71° F. (22° C.) and a pressure of 1 atmosphere “atm” (0.1 megapascals “MPa”). A fluid can be a liquid or gas. A homogenous fluid has only one phase; whereas a heterogeneous fluid has more than one distinct phase. A colloid is an example of a heterogeneous fluid. A colloid can be: a slurry, which includes a continuous liquid phase and undissolved solid particles as the dispersed phase; an emulsion, which includes a continuous liquid phase and at least one dispersed phase of immiscible liquid droplets; a foam, which includes a continuous liquid phase and a gas as the dispersed phase; or a mist, which includes a continuous gas phase and liquid droplets as the dispersed phase.

Oil and gas hydrocarbons are naturally occurring in some subterranean formations. A subterranean formation containing oil or gas is sometimes referred to as a reservoir. A reservoir may be located under land or off shore. Reservoirs are typically located in the range of a few hundred feet (shallow reservoirs) to a few tens of thousands of feet (ultra-deep reservoirs). In order to produce oil or gas, a wellbore is drilled into a reservoir or adjacent to a reservoir.

A well can include, without limitation, an oil, gas or water production well, an injection well, or a geothermal well. As used herein, a “well” includes at least one wellbore. A wellbore can include vertical, inclined, and horizontal portions, and it can be straight, curved, or branched. As used herein, the term “wellbore” includes any cased, and any uncased, open-hole portion of the wellbore. A near-wellbore region is the subterranean material and rock of the subterranean formation surrounding the wellbore. As used herein, a “well” also includes the near-wellbore region. The near-wellbore region is generally considered to be the region within approximately 100 feet of the wellbore. As used herein, “into a well” means and includes into any portion of the well, including into the wellbore or into the near-wellbore region via the wellbore.

A portion of a wellbore may be an open hole or cased hole. In an open-hole wellbore portion, a tubing string may be placed into the wellbore. The tubing string allows fluids to be introduced into or flowed from a remote portion of the wellbore. In a cased-hole wellbore portion, a casing is placed into the wellbore, which can also contain a tubing string. A wellbore can contain an annulus. Examples of an annulus include, but are not limited to: the space between the wellbore and the outside of a tubing string in an open-hole wellbore; the space between the wellbore and the outside of a casing in a cased-hole wellbore; and the space between the inside of a casing and the outside of a tubing string in a cased-hole wellbore.

Many components of a well system are made from metals or metal alloys. These components are susceptible to corrosion. Corrosion is the wearing away of metals due to a chemical reaction. Corrosion can occur in a variety of ways, for example, when the metal is exposed to oxygen in the surrounding environment or when the metal is in contact with a fluid having a low enough pH, for example a pH in the acidic range. Corrosion of metal well components can be quite detrimental to oil or gas operations.

During wellbore operations, it is common to introduce a treatment fluid into the well. Examples of common treatment fluids include, but are not limited to, drilling fluids, spacer fluids, completion fluids, and work-over fluids. As used herein, a “treatment fluid” is a fluid designed and prepared to resolve a specific condition of a well or subterranean formation, such as for stimulation, isolation, gravel packing, or control of gas or water coning. The term “treatment fluid” refers to the specific composition of the fluid as it is being introduced into a well. The word “treatment” in the term “treatment fluid” does not necessarily imply any particular action by the fluid.

It is common to deposit a filtercake in a portion of a well. A filtercake is the residue deposited on a permeable medium when a slurry, such as a drilling fluid, is forced against the medium under pressure. The filtrate is the liquid that passes through the medium, leaving the cake on the medium. In filtercake deposition, the slurry, that commonly includes water, a gelling agent, calcium carbonate, and polymers, is introduced into the open-hole wellbore. The fluid flows into a desired portion of the well. The ingredients in the fluid form the filtercake during subsequent completion operations. The filtercake can be used to bind fines, such as sand, together, can also reduce damage to formation permeability, and can also stabilize the wellbore.

It is often desirable to remove at least a portion of a filtercake at some stage in the production process. The filtercake is often removed in order to restore fluid flow between the wellbore and the subterranean formation. One common technique for removing a filtercake is to perform an acid wash. In an acid wash, a wash pipe is inserted into the wellbore. An aqueous solution of an acid or an acid precursor is then flowed through the wash pipe under pressure and the acid comes in contact with the filtercake. The acid can chemically react with some of the ingredients in the filtercake, causing those ingredients to solubilize, and thus causing the filtercake to be removed from the well. The acid wash can also be used to penetrate into the subterranean formation in order to increase the permeability of the formation.

It may be desirable to use a delayed acid breaker system in an acid wash operation. The delayed acid breaker system can be used to allow the treatment fluid to be introduced into the desired portion of the well for filtercake removal. A delayed acid breaker system can include the introduction of an acid precursor into the well. As used herein, an “acid precursor” is an anion (e.g., a salt or an ester) that forms an acid in the presence of water. Generally, release of the acid from the precursor is slow; depending upon temperature. It is common for it to take up to two days for all the acid to be released. This slow release of the acid allows the treatment fluid to be introduced into the desired portion of the well to be treated.

However, it is not uncommon for an acid to cause corrosion to metal well components, due to the low pH of the fluid. Therefore, it is common to include a corrosion inhibitor in treatment fluids that either have or may have a pH low enough to cause corrosion. Organic inhibitors can work by adsorbing themselves on the metallic surface, protecting the metallic surface by forming a film. Inhibitors can be distributed from a solution or dispersion. Some are included in a protective coating formulation. For example, a corrosion inhibitor can be added to an acid wash and can function by adsorbing on a metal surface to form a protective film. The protective film decreases the destructive reaction of the acid with the metal. Generally, a corrosion inhibitor does not completely stop the corrosion reaction, but it can eliminate more than 99% of the metal losses that would occur if the inhibitor were not present. It is preferred that the inhibitor has little or no effect on the reaction rate of the acid with limestone, dolomite or acid-soluble minerals in the filtercake.

A corrosion inhibitor can be a polymer. A polymer is a large molecule composed of repeating units, typically connected by covalent chemical bonds. A polymer is formed from monomers. During the formation of the polymer, some chemical groups can be lost from each monomer. The piece of the monomer that is incorporated into the polymer is known as the repeating unit or monomer residue. The backbone of the polymer is the continuous link between the monomer residues. The polymer can also contain functional groups connected to the backbone at various locations along the backbone. Polymer nomenclature is generally based upon the type of monomer residues comprising the polymer. A polymer formed from one type of monomer residue is called a homopolymer. A copolymer is formed from two or more different types of monomer residues. The number of repeating units of a polymer is referred to as the chain length of the polymer. The number of repeating units of a polymer can range from approximately 11 to greater than 10,000. In a copolymer, the repeating units from each of the monomer residues can be arranged in various ways along the polymer chain. For example, the repeating units can be random, alternating, periodic, or block. The conditions of the polymerization reaction can be adjusted to help control the average number of repeating units (the average chain length) of the polymer. As used herein, a “polymer” can include a cross-linked polymer. As used herein, a “cross link” or “cross linking” is a connection between two polymer molecules. A cross-link between two polymer molecules can be formed by a direct interaction between the polymer molecules, or conventionally, by using a cross-linking agent that reacts with the polymer molecules to link the polymer molecules.

A polymer has an average molecular weight, which is directly related to the average chain length of the polymer. The average molecular weight of a polymer has an impact on some of the physical characteristics of a polymer, for example, its solubility in water, its viscosity, and its biodegradability. For a copolymer, each of the monomers will be repeated a certain number of times (number of repeating units). The average molecular weight for a copolymer can be expressed as follows:

Avg. molecular weight=(M·W·m₁*RUm₁)+(M·W·m₂*RUm₂) . . .

where M·W·m₁ is the molecular weight of the first monomer; RU m₁ is the number of repeating units of the first monomer; M·W·m₂ is the molecular weight of the second monomer; and RU m₂ is the number of repeating units of the second monomer. Of course, a terpolymer would include three monomers; a tetra polymer would include four monomers, and so on.

A variety of corrosion inhibitors and formulations, which can be added to aqueous corrosive fluids, have been developed and used in the Oil and Gas industry. While such inhibitors and formulations have achieved varying degrees of success in preventing corrosion of metal surfaces, there is a continuing need for improved corrosion inhibitors that are not only environmentally-friendly, but also effective in protecting the metal from corrosion when combined with the aqueous fluids of the type described above. There is also a need for biodegradable corrosion inhibitors.

As used herein the “corrosion weight loss” (CWL) of a material is tested according to the following procedure. A test fluid is mixed by first adding a specified concentration of a water-soluble salt and a specified volume of deionized water to a mixing container. The container is placed on a mixer base. The motor of the base is then turned on and maintained at approximately 2,000 revolutions per minute (rpm) for approximately 60 seconds (s) (+/−1 s) until all the salt is in solution. The container is then removed from the mixer base, and a specified concentration of a carboxylate is added to a desired volume of the salt-water solution. The container is then placed on a magnetic stirrer plate and the fluid is stirred with a magnetic stirring rod for approximately 5 min. A specified concentration of the corrosion inhibitor is then added to the fluid and stirred on the magnetic stirring plate for approximately 5 min. It is to be understood that the test fluid is mixed at ambient temperature and pressure (about 71° F. (22° C.) and about 1 atm (0.1 MPa)). After the test fluid is ramped up to the specified temperature and specified pressure, the treatment fluid is maintained at that temperature and pressure for the duration of the testing. At least one clean and dry metal plate is weighed to at least the nearest 1/10 of a milligram (mg) to determine the first weight. The metal is selected based on the particular metal of interest. The metal can also be a metal alloy. The at least one metal plate is then threaded onto a Teflon® rod. The metal plate(s) and rod are placed into the container such that the metal plate has no contact with the inside of the container. The required volume of test fluid is poured into the container gently, down the side of the container so no air bubbles are trapped around the plate assembly. The required volume of fluid to plate surface area ratio is 20 milliliters/inches² (mL/in²). The container is inserted into a high-pressure, high-temperature (HPHT) cell and a Teflon® lid is placed over the container. The cell is pressurized to the specified pressure with nitrogen gas. The aging cell is placed into an oven, pre-heated to the specified temperature for the specified time. The aging cell is allowed to cool for at least one hour. The cell is de-pressurized. The metal plate(s) is removed from the container and test fluid. The plate(s) is disassembled from the rod and corrosion products are removed. The plate(s) are washed with 15% hydrochloric acid, followed by water and then acetone, dried, and weighed to the nearest 1/10 of a mg to determine the second weight. The corrosion weight loss is calculated for each plate using the following equation and is reported in units of pounds per square feet (lb/ft²). A corrosion weight loss of less than 0.05 lb/ft² can be considered acceptable.

$$C W L = \frac{( weight loss ) ( 0.3175 )}{surface area}$$

where weight loss=initial weight minus final weight in grams; and surface area=the total surface area of the metal plate exposed to acid in square inches (in²). The corrosion rate (CR) for each plate can also be calculated as follows, expressed in units of mils per year lost (mpy), wherein “mils” is defined as 1/1,000 of an inch:

$$C R = \frac{W L * 22 , 300}{A * d * t}$$

where: WL=weight loss in grams; A=surface area of plate in inches²; d=density of the plate in grams per square centimeters (g/cm²); and t=time of exposure of the plate to a corrosive environment in days.

It is desirable for a treatment fluid additive, such as a corrosion inhibitor, to be environmentally friendly. The OSPAR (Oslo/Paris convention for the Protection of the Marine Environment of the North-East Atlantic) Commission has developed a pre-screening scheme for evaluating chemicals used in off-shore drilling. According to OSPAR, a chemical used in off-shore drilling should be substituted with an environmentally-friendly chemical if any of the following are met: a. it is on the OSPAR LCPA (List of Chemicals for Priority Action); b. it is on the OSPAR LSPC (List of Substances of Possible Concern); c. it is on Annex XIV or XVII to REACH (Regulation (EC) No 1907/2006 of the European Parliament and of the Council of 18 Dec. 2006 concerning the Registration, Evaluation, Authorisation and Restriction of Chemicals); d. it is considered by the authority, to which the application has been made, to be of equivalent concern for the marine environment as the substances covered by the previous sub-paragraphs; e. it is inorganic and has a LC₅₀ or EC₅₀ less than 1 mg/l; f. it has an ultimate biodegradation (mineralization) of less than 20% in OECD 306, Marine BODIS or any other accepted marine protocols or less than 20% in 28 days in freshwater (OECD 301 and 310); g. half-life values derived from simulation tests submitted under REACH (EC 1907/2006) are greater than 60 and 180 days in marine water and sediment respectively (e.g. OECD 308, 309 conducted with marine water and sediment as appropriate); or h. it meets two of the following three criteria: (i) biodegradation: less than 60% in 28 days (OECD 306 or any other OSPAR-accepted marine protocol), or in the absence of valid results for such tests: less than 60% (OECD 301B, 301C, 301D, 301F, Freshwater BODIS); or less than 70% (OECD 301A, 301E); (ii) bioaccumulation: BCF>100 or log P_{ow}≧3 and molecular weight<700, or if the conclusion of a weight of evidence judgement under Appendix 3 of OSPAR Agreement 2008-5 is negative; or (iii) toxicity: LC₅₀<10 mg/l or EC₅₀<10 mg/l; if toxicity values<10 mg/l are derived from limit tests to fish, actual fish LC₅₀ data should be submitted. As used herein, a polymer is considered to be “environmentally friendly” if any of the above conditions are not satisfied.

As used herein, a polymer (such as a polymer, cross-linked polymer, or grafted copolymer) is considered “biodegradable” if the polymer passes the OECD TG 306: Closed Bottle Seawater test. In accordance with Organisation for Economic Co-operation and Development (OECD) guidelines, a polymer showing more than 20% biodegradability in 28 days according to the 306 test can be classified as primary biodegradable. A polymer showing more than 60% biodegradability in 28 days (or if the polymer is just below the 60% mark, then the test period can be extended by a few days) according to the 306 test can be classified as ultimate biodegradable, and it may be assumed that the polymer will undergo rapid and ultimate degradation in a marine environment. A polymer can be classified as primary or ultimate biodegradable if it passes the 306 test. Seawater generally contains the following major elements (by percentage): 85.84% oxygen; 10.82% hydrogen; 1.94% chlorine; 1.08% sodium; 0.13% magnesium; 0.09% sulfur; 0.04% calcium; 0.04% potassium; 0.007% bromine; and 0.003% carbon. The 306 test is performed as follows. A solution of the polymer in seawater, usually at 2-5 milligrams per liter (mg/L), is inoculated with a relatively small number of microorganisms from a mixed population and kept in completely full, closed bottles in the dark at a constant temperature. Degradation is followed by analysis of dissolved oxygen over a 28 day period. The amount of oxygen taken up by the microbial population during biodegradation of the test polymer, corrected for uptake by the blank inoculum run in parallel, is expressed as a percentage of ThOD or, less satisfactorily COD.

According to an embodiment, a method of treating a portion of a well comprises: forming a treatment fluid, wherein the treatment fluid comprises: (A) water; (B) a carboxylate; and (C) a corrosion inhibitor, wherein the corrosion inhibitor is environmentally-friendly, biodegradable, and is a polymer, wherein the polymer comprises a carbohydrate backbone and a quaternary amine functional group; wherein a test fluid consisting essentially of the water, the carboxylate, and the corrosion inhibitor, and in the same proportions as in the treatment fluid, is capable of providing a corrosion weight loss to a metal plate of less than 0.05 pounds per square feet (lb/ft²) under testing conditions of 200° F. (93.3° C.), a pressure of 500 psi (3.4 MPa), and a time of 24 hours whereas a substantially identical test fluid without the corrosion inhibitor provides a corrosion weight loss of greater than 0.05 lb/ft² under the testing conditions; and introducing the treatment fluid into the well.

According to another embodiment, a method of treating a portion of a well comprises: forming a treatment fluid, wherein the treatment fluid comprises: (A) water; (B) a carboxylate, wherein the carboxylate is capable of forming a carboxylic acid in the presence of the water; and (C) a corrosion inhibitor, wherein the corrosion inhibitor: (i) is environmentally-friendly and biodegradable; and (ii) is a polymer, wherein the polymer comprises a carbohydrate backbone and a quaternary amine functional group; and introducing the treatment fluid into the well.

According to another embodiment, a treatment fluid comprises: water; a carboxylate; and a corrosion inhibitor, wherein the corrosion inhibitor is environmentally-friendly, biodegradable, and is a polymer, wherein the polymer comprises a carbohydrate backbone and a quaternary amine functional group; wherein a test fluid consisting essentially of the water, the carboxylate, and the corrosion inhibitor, and in the same proportions as in the treatment fluid, is capable of providing a corrosion weight loss to a metal plate of less than 0.05 pounds per square feet (lb/ft²) under testing conditions of 200° F. (93.3° C.), a pressure of 500 psi (3.4 MPa), and a time of 24 hours whereas a substantially identical test fluid without the corrosion inhibitor provides a corrosion weight loss of greater than 0.05 lb/ft² under the testing conditions.

It is to be understood that the discussion of preferred embodiments regarding the treatment fluid or any ingredient in the treatment fluid, is intended to apply to the composition embodiments and the method embodiments. Any reference to the unit “gallons” means U.S. gallons.

The treatment fluid includes water. The treatment fluid can be a homogenous fluid or a heterogeneous fluid. Preferably, the water is the base fluid of the treatment fluid. The treatment fluid can be a colloid, such as a slurry, emulsion, or foam. If the treatment fluid is a colloid, then preferably the water comprises the liquid continuous phase of the colloid, wherein the water is the base fluid. The liquid continuous phase can include dissolved materials and/or undissolved solids. The water can be selected from the group consisting of freshwater, seawater, brine, and any combination thereof in any proportion. The treatment fluid can further include a water-soluble salt. Preferably, the salt is selected from sodium chloride, calcium chloride, calcium bromide, potassium chloride, potassium bromide, magnesium chloride, and any combination thereof. The treatment fluid can contain the water-soluble salt in a concentration in the range of about 5% to about 35% by weight of the water (bww).

The treatment fluids for any of the embodiments include a carboxylate. As used herein a “carboxylate” is a salt or ester of carboxylic acid. According to an embodiment, the carboxylate is a carboxylate salt. A salt is an ionic compound that is formed by replacing one or more of the hydrogen ions of an acid with a different cation. A carboxylate salt has the general formula M(RCOO)ₙ where M is a metal, R can be hydrogen (H) or organic groups (e.g., methyl, ethyl, propyl, etc.), and n is a number (e.g., 1, 2, 3 . . . ). A carboxylate salt can also include a metal. According to another embodiment, the carboxylate is a carboxylate ester. A carboxylate ester is a compound in which the hydrogen atom of a carboxylic acid is replaced by a hydrocarbon group. A carboxylate ester has the general formula RCOOR′ where R and R′ are organic groups and R′ is not a hydrogen atom. Examples of suitable esters include ethyl acetate, ethyl lactate, ethyl formate, isobutyl acetate, and isobutyl formate. Examples of suitable formate esters include, ethylene glycol monoformate, ethylene glycol diformate, diethylene glycol diformate, glycerylmonoformate, glyceryldiformate, glyceryltriformate, triethylene glycol diformate and formate esters of pentaerythritol, and are discussed in U.S. Pat. No. 6,877,563, issued to Bradley L. Todd and Eric Davidson on Apr. 12, 2005, which is hereby incorporated by reference in its entirety for all purposes. The carboxylate can be selected from the group consisting of formate, acetate, lactate, oxalate, and citrate.

According to an embodiment, the carboxylate is capable of forming or forms a carboxylic acid in the presence of the water. The formation of the carboxylic acid can occur via hydrolysis of the carboxylate and water, wherein the carboxylate gains a hydrogen atom from the water to form carboxylic acid. A common kind of hydrolysis occurs when a salt of a weak acid or weak base (or both) is dissolved in water. Water spontaneously ionizes into hydroxyl anions and hydrogen cations. The salt, too, dissociates into its constituent anions and cations. For example, sodium acetate dissociates in water into sodium and acetate ions. The sodium ions react very little with the hydroxyl ions; whereas, the acetate ions combine with hydrogen ions to form acetic acid. The carboxylic acid can be, without limitation, formic acid, acetic acid, lactic acid, oxalic acid, or citric acid. The type of carboxylic acid formed will depend on the carboxylate selected. For example, if a formate is selected, then the carboxylic acid will be formic acid—if a citrate is selected, then the carboxylic acid will be citric acid, and so on.

The carboxylate can be part of a delayed acid breaker system. An example of a commercially-available delayed acid breaker system is N-FLOW™, marketed by Halliburton Energy Services, Inc. According to an embodiment, the formation of the carboxylic acid from the carboxylate and the water is delayed for a desirable amount of time. Preferably, the desired amount of time is at least the necessary time to introduce the treatment fluid into the well. According to another embodiment, the carboxylic acid is capable of dissolving or dissolves at least a portion of a filtercake. By way of example, the treatment fluid can be introduced into a well, the carboxylate begins hydrolysis via a reaction with the water, the bottomhole temperature can act as a catalyst for the hydrolysis of the carboxylate, the carboxylic acid can then dissolve at least a portion of the filtercake. According to an embodiment, the carboxylate is in a sufficient concentration such that the hydrolyzed carboxylate is capable of dissolving or dissolves at least a portion of the filtercake. According to another embodiment, the carboxylate is in a concentration of at least 5% by weight of water (bww) in the treatment fluid. The carboxylate can also be in a concentration in the range of about 5% to about 25%, preferably about 10% to about 20% by weight of the water in the treatment fluid.

The methods can further include the step of causing or allowing the formation of the carboxylic acid. The step of causing or allowing can include introducing heat into the bottomhole portion of the well. In this manner, the increase in temperature can function as a catalyst for the hydrolysis of the carboxylate.

The treatment fluid includes the corrosion inhibitor. The corrosion inhibitor is a polymer. The polymer can be a copolymer. The polymer can be a cationic surfactant. The polymer comprises a carbohydrate backbone. A carbohydrate can be a monomer residue that includes at least the elements carbon, hydrogen, and oxygen (usually with a hydrogen to oxygen ratio of 2:1). A carbohydrate can be a monosaccharide, disaccharide, oligosaccharide, or polysaccharide. Preferably, the carbohydrate is a sugar or cellulose. By way of example, the polymer and the sugar backbone can be formed from the polymerization reaction of quaternized alkyl polyglucosides or polyquaternized alkyl polyglucosides and the like; and the polymer and the cellulose backbone can be formed from the polymerization of quaternized polycelluloses or polyquaternized polycelluloses and the like. The backbone can include other monomer residues besides the carbohydrate. The polymer is environmentally-friendly and biodegradable. According to an embodiment, the carbohydrate backbone is environmentally-friendly and biodegradable. Preferably, any other monomer residues besides the carbohydrate making up the backbone of the polymer are environmentally-friendly and biodegradable. The polymer can be primary or ultimate biodegradable. The natural origin of the polymers according to the embodiments can allow the polymer to be environmentally-friendly and biodegradable. According to another embodiment, the corrosion inhibitor polymer is non-bioaccumulative. Bioaccumulation refers to the accumulation of toxic substances, such as pesticides, or other organic chemicals in an organism in which the organism absorbs the toxic substance at a rate greater than that at which the substance is lost from the organism.

The polymer also includes a quaternary amine functional group. According to an embodiment, the polymer includes two or more quaternary amine functional groups. The polymer can include 1 to about 20 quaternary amine functional groups. A quaternary amine is a nitrogen atom bonded to four groups and carries a positive charge. The polysaccharide starting materials can be provided with quaternary nitrogen-containing substituents through quaternization reactions. Quaternization can be achieved by reacting the polysaccharides with quaternizing agents which are quaternary ammonium salts, including mixtures thereof, to effect substitution of the polysaccharide chain with quaternary nitrogen-containing groups. Typical quaternary ammonium salts which can be utilized include, but are not limited to quaternary nitrogen-containing halides, halohydrins and epoxides. The quaternary ammonium salt may contain hydrophobes. According to an embodiment, the quaternary amine functional group is capable of forming or forms a film on a metal surface.

The following is one example of a suitable chemical structure for a polymer having a sugar backbone and two or more quaternary amine functional groups.

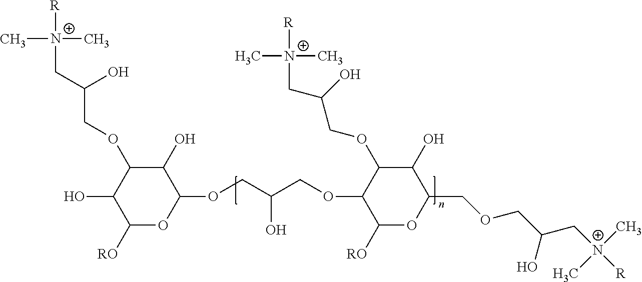

where R is an alkyl group having from about 6 to about 22 carbon atoms and n is an integer ranging from 4 to 6. Preferably, R is an alkyl group having from about 8 to about 12 carbon atoms, more preferably about 10 to about 12 carbon atoms. Examples of commercially suitable poly quaternary functionalized alkyl polyglucosides useful in the present invention include, but are not limited to: POLY SUGA®QUAT series of quaternary functionalized alkyl polyglucosides, available from Colonial Chemical, Inc., located in South Pittsburg, Term. The POLY SUGA®QUAT series are made from short and long chain quats reacted onto polymerized alkyl polyglucoside sugars. The term “alkyl” refers to a straight or branched chain monovalent hydrocarbon radicals having a specified number of carbon atoms. Alkyl groups may be unsubstituted or substituted with substituents that do not interfere with the specified function of the composition and may be substituted once or twice with the same or different group. Substituents may include alkoxy, hydroxy, mercapto, amino, alkyl substituted amino, nitro, carboxy, carbanyl, carbanyloxy, cyano, methyl sulfonyl amino, or halogen, for example. Examples of “alkyl” include, but are not limited to, methyl, ethyl, n-propyl, isopropyl, n-butyl, s-butyl, t-butyl, n-pentyl, n-hexyl, 3-methylpentyl, and the like.

The following is one example of a suitable chemical structure for a polymer having a cellulose backbone and two or more quaternary amine functional groups.

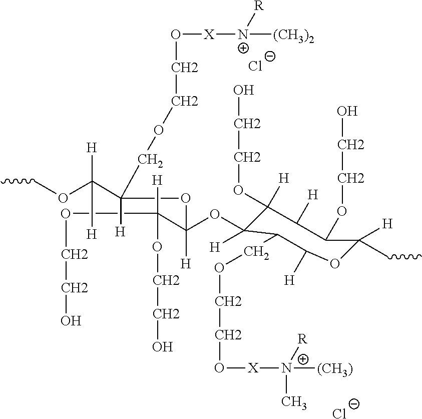

where R is an alkyl group having a chain length ranging from about 10 to about 20 carbon atoms, and X is methylene, ethylene, propylene, or 2-propenol. Commercially-available cellulose backbone polymers include, but are not limited to, CRODACEL™ QL, QM, or QS, where QL=Lauryl, QM=Coco, and QS=Stearyl, available from Croda, Inc. According to an embodiment, the polymer according to this aspect contains an average of 1.2 moles of fatty quaternary groups per anhydro glucose unit.

The polymer can have a molecular weight such that the polymer is hydrophilic. The polymer can also have a molecular weight such that the polymer is water soluble. As used herein, the term “soluble” means that at least 1 part of the substance dissolves in 20 parts of the liquid at a temperature of 75° F. (24° C.) and a pressure of 1 atm (0.1 MPa). According to an embodiment, the polymer has a molecular weight such that the polymer is biodegradable. The polymer can have a molecular weight of at least 1,000. The polymer can have a molecular weight in the range of about 1,000 to about 1,000,000, preferably about 10,000 to about 1,000,000.

According to an embodiment, a test fluid consisting essentially of the water, the carboxylate, and the corrosion inhibitor, and in the same proportions as in the treatment fluid, is capable of providing or provides a corrosion weight loss to a metal plate of less than 0.05 pounds per square feet (lb/ft²) under testing conditions of 200° F. (93.3° C.), a pressure of 500 psi (3.4 MPa), and a time of 24 hours whereas a substantially identical test fluid without the corrosion inhibitor provides a corrosion weight loss of greater than 0.05 lb/ft² under the testing conditions. The metal or metal alloy of the plate can be selected based on the metal that is anticipated to be encountered in actual working conditions. For example, the metal of the metal plate can be steel, zinc, iron, 13Cr, SS304, SS316, N80, and P110.

According to another embodiment, the test fluid is also capable of providing a corrosion rate to the metal plate equal to or less than 50 mils per year (mpy) under testing conditions consisting of a temperature of 200° F. (93.3° C.), a pressure of 500 psi (3.4 MPa), and a time of 7 days, whereas a substantially identical test fluid without the corrosion inhibitor provides a corrosion rate of greater than 50 mpy under the testing conditions.

The corrosion inhibitor can be in a concentration such that the polymer is environmentally-friendly and biodegradable. According to an embodiment, the corrosion inhibitor is in at least a sufficient concentration such that the test fluid provides a corrosion weight loss to the metal plate of less than 0.05 lb/ft², preferably less than 0.03 lb/ft², under the testing conditions. According to another embodiment, the corrosion inhibitor is in at least a sufficient concentration such that the test fluid provides a corrosion rate to the metal plate less than 50 mpy under the testing conditions. According to yet another embodiment, the number of quaternary amine functional groups of the polymer is at least sufficient such that the test fluid provides a corrosion weight loss to the metal plate of less than 0.05 lb/ft², preferably less than 0.03 lb/ft², under the testing conditions and/or a corrosion rate less than 50 mpy under the testing conditions. By way of example, the polymer can be formed such that a desired number of quaternary amine functional groups are present. The desired number of quaternary amine functional groups can be selected based on the concentration of the carboxylate and the anticipated concentration of the carboxylic acid to be formed.

The corrosion inhibitor can be in a concentration of at least 0.5% by volume of the water. The corrosion inhibitor can also be in a concentration in the range of about 0.5% to about 5% by volume of the water, preferably about 1% to about 4% by volume.

The treatment fluid can further include additional additives including, but not limited to, corrosion inhibitor intensifiers, pH buffers, viscosifiers, emulsifiers, weighting agents, fluid loss additives, friction reducers, surface wetting agents, surfactants, solvents, scale inhibitors, catalysts, clay stabilizers, gases, foaming agents, iron control agents, and solubilizers.

The treatment fluid can include a corrosion inhibitor intensifier. The corrosion inhibitor intensifier can comprise metal ions, halide ions, or certain organic compounds. Halide ions have proven to be an effective inhibitor intensifier in high-temperature environments, especially for hydrochloric acid-formic acid mixtures. Commercially-available examples of a corrosion inhibitor intensifier include HII-124B™, HII-124F™, and HII-124C™, marketed by Halliburton Energy Services, Inc. The corrosion inhibitor intensifier can be in a concentration in the range of about 30 to about 200 pounds per 1,000 gallons of the treatment fluid.

According to an embodiment, the treatment fluid provides a corrosion weight loss to the metal plate of less than 0.05 lb/ft², preferably less than 0.03 lb/ft² at a temperature of 200° F. (93.3° C.), a pressure of 500 psi (3.4 MPa), and a time of 24 hours. According to another embodiment, the treatment fluid provides a corrosion weight loss to a metal component of a wellbore of less than 0.05 lb/ft², preferably less than 0.03 lb/ft², at the bottomhole conditions of the well. As used herein, the term “bottomhole” means the location of the wellbore to be treated. According to an embodiment, the treatment fluid provides a corrosion rate to the metal plate of less than 50, preferably less than 40, more preferably less than 20 mpy at a temperature of 200° F. (93.3° C.), a pressure of 500 psi (3.4 MPa), and a time of 7 days. According to another embodiment, the treatment fluid provides a corrosion rate to a metal component of a wellbore of less than 50, preferably less than 40, more preferably less than 20 mpy at the bottomhole conditions of the well.

The treatment fluid can be, without limitation, a drilling fluid, spacer fluid, completion fluid, a work-over fluid, a stimulation fluid (e.g., a fracturing fluid or acidizing fluid), or a packer fluid.

The methods include the step of forming the treatment fluid. The treatment fluid can be formed ahead of use or on the fly. The methods include the step of introducing the treatment fluid into the well. The step of introducing can comprise pumping the treatment fluid into the well. The well can be, without limitation, an oil, gas, or water production well, or an injection well. According to an embodiment, the well penetrates a reservoir or is located adjacent to a reservoir. The well can preferably be an off-shore well. The methods can further include the step of removing at least a portion of the treatment fluid after the step of introducing. The methods can include the additional steps of perforating, fracturing, or performing an acidizing treatment, after the step of introducing.

### Examples

To facilitate a better understanding of the present invention, the following examples of certain aspects of preferred embodiments are given. The following examples are not the only examples that could be given according to the present invention and are not intended to limit the scope of the invention.

Unless stated otherwise, all of the treatment fluids were mixed and tested according to the procedure for the specific test as described in The Detailed Description section above. The corrosion weight loss and corrosion rate tests were conducted on 1010 steel plates at a temperature of 150° F. (65.6° C.) or 200° F. (93.3° C.), a pressure of 500 psi (3.4 MPa), and a time of either 24 hours or 7 days. Each of the treatment fluids contained at least: deionized water; sodium chloride salt at a concentration of 9.2 pounds per gallon (ppg) of the water; and a formate ester-based delayed acid breaker system at a concentration of 10% by volume of the water. All other test fluids, except the blank, also contained varying concentrations of corrosion inhibitors of: benzalkonium chloride (CI-121, available from Imperial Oilfield Chemicals Pvt. Ltd. in Vadodara, India); POLY SUGA®QUAT S1010P, a polymer having a stearylquat sugar backbone having alkyl groups containing C10-C16 and a quaternary amine functional group, available from Colonial Chemicals in South Pittsburg Tenn.; CRODACEL™ QM-LQ-(WD) polymeric cellulosic quat with coco (C₁₂) available from Croda Chemicals Europe, Ltd. in Great Britain; or CRODACEL™ QS-SS-(WD) polymeric cellulosic quat with stearyl (C₁₈) available from Croda Chemicals Europe, Ltd. in Great Britain, expressed in units of percent by volume of the water (% vl). Some of the treatment fluids further included HII-124B™ corrosion inhibitor intensifier in units of pounds per 1,000 gallons (lb/1,000 gal) of the treatment fluid.

Table 1 contains type of corrosion inhibitor, corrosion inhibitor concentrations (% vl), corrosion inhibitor intensifier concentrations (lb/1,000 gal), corrosion weight loss in pounds per square feet (lb/sq. ft.), and corrosion rate data in mils per year (mpy) for several treatment fluids at a time of 24 hours and 7 days and a temperature of 150° F. (65.6° C.).

TABLE 1

| | | | Conc. of | 24 hours | | 7 days | |
|---|---|---|---|---|---|---|---|
| | | Conc. of | Corrosion | Corrosion | | Corrosion | |
| | | Corrosion | Inhibitor | Weight Loss | Corrosion | Weight Loss | Corrosion |
| Fluid # | Type of Corrosion Inhibitor | Inhibitor | Intensifier | (lb/sq. ft.) | Rate (mpy) | (lb/sq. ft.) | Rate (mpy) |
| 1 | Blank | 0 | 0 | 0.0570 | 509.66 | 0.2148 | 274.19 |
| 2 | benzalkonium chloride | 1% | 0 | 0.0043 | 38.23 | 0.0227 | 28.99 |
| 3 | POLY SUGA ®QUAT S1010P | 1% | 0 | 0.0044 | 38.96 | 0.0240 | 30.66 |
| 4 | CRODOCEL ™ QM-LQ-(WD) | 1% | 0 | 0.0035 | 31.46 | 0.0223 | 28.44 |
| 5 | CRODOCEL ™ QS-SS-(WD) | 1% | 120 | — | — | 0.0053 | 6.82 |

As can be seen in Table 1, at a time of 24 hours and 7 days, all of the treatment fluids except the blank had a corrosion weight loss of less than 0.05 lb/sq. ft. and a corrosion rate of less than 50 mpy. Moreover, as can be seen in Table 1, treatment fluid #5, containing a polymeric corrosion inhibitor and a corrosion inhibitor intensifier, exhibited a much lower corrosion weight loss and corrosion rate compared to treatment fluids #3 and 4 containing only the polymeric corrosion inhibitor without the corrosion inhibitor intensifier. This indicates that the addition of a corrosion inhibitor intensifier can increase the effectiveness of the corrosion inhibitor. Furthermore, CI-121 is toxic whereas, POLY SUGA®QUAT S1010P and CRODACEL™ are environmentally-friendly and biodegradable.

Table 2 contains type of corrosion inhibitor, corrosion inhibitor concentrations (% vl), corrosion inhibitor intensifier concentrations (lb/1,000 gal), corrosion weight loss in pounds per square feet (lb/sq. ft.), and corrosion rate data in mils per year (mpy) for several treatment fluids at a time of 24 hours and 7 days and a temperature of 200° F. (93.3° C.).

TABLE 2

| | | | Conc. of | 24 hours | | 7 days | |
|---|---|---|---|---|---|---|---|
| | | Conc. of | Corrosion | Corrosion | | Corrosion | |
| | | Corrosion | Inhibitor | Weight Loss | Corrosion | Weight Loss | Corrosion |
| Fluid # | Type of Corrosion Inhibitor | Inhibitor | Intensifier | (lb/sq. ft.) | Rate (mpy) | (lb/sq. ft.) | Rate (mpy) |
| 1 | Blank | 0 | 0 | 0.1498 | 1,338.69 | 0.4126 | 526.74 |
| 2 | benzalkonium chloride | 1% | 0 | 0.0227 | 28.99 | 0.1106 | 141.18 |
| 3 | benzalkonium chloride | 1% | 30 | 0.0106 | 94.88 | 0.0293 | 37.35 |
| 4 | POLY SUGA ®QUAT S1010P | 1% | 0 | 0.0285 | 254.23 | 0.1365 | 174.21 |
| 5 | POLY SUGA ®QUAT S1010P | 2% | 0 | 0.0267 | 238.57 | — | — |
| 6 | POLY SUGA ®QUAT S1010P | 1% | 30 | 0.0139 | 124.41 | 0.0419 | 53.47 |
| 7 | POLY SUGA ®QUAT S1010P | 1% | 120 | — | — | 0.0255 | 32.55 |
| 8 | CRODOCEL ™ QM-LQ-(WD) | 1% | 0 | 0.0183 | 163.27 | 0.1412 | 180.21 |
| 9 | CRODOCEL ™ QM-LQ-(WD) | 1% | 30 | — | — | 0.0641 | 81.84 |
| 10 | CRODOCEL ™ QM-LQ-(WD) | 1% | 120 | — | — | 0.0231 | 29.42 |
| 11 | CRODOCEL ™ QS-SS-(WD) | 1% | 0 | 0.0144 | 129.10 | — | — |
| 12 | CRODOCEL ™ QS-SS-(WD) | 1% | 120 | — | — | 0.0290 | 36.99 |

As can be seen in Table 2, at a higher temperature, treatment fluids #1 and 2 had an acceptable corrosion weight loss and corrosion rate at a time of 24 hours, but not at a time of 7 days. However, with the addition of a corrosion inhibitor intensifier in treatment fluid #3 (compared to fluid #2), the corrosion weight loss and corrosion rate decreased to acceptable values at a time of 7 days. This indicates that the addition of a corrosion inhibitor intensifier can help provide desired values. Treatment fluids #4-12 contained a polymeric corrosion inhibitor. As can be seen, fluids #4 and 5 had a corrosion rate greater than 50 mpy at a time of 24 hours. By increasing the concentration of the corrosion inhibitor in fluid #5, the corrosion weight loss and corrosion rate decreased slightly. The addition of a corrosion inhibitor intensifier at a concentration of 30 lb/1,000 gal in fluid #6 reduced the corrosion weight loss and corrosion rate compared to fluid #4 at a time of 24 hours. Moreover, by increasing the concentration of the corrosion inhibitor intensifier in fluid #7 resulted in acceptable corrosion weight loss and corrosion rate compared to fluid #6 and also decreased the corrosion rate to an acceptable value in fluid #7 compared to fluid #6. The same trend can also be observed when comparing fluids #8-10 at a time of 7 days. This indicates that the presence and the concentration of a corrosion inhibitor intensifier can help provide desirable values. As can also be seen, fluids #4, 8, and 11 all exhibited a corrosion weight loss of less than 0.05 lb/sq. ft. at a time of 24 hours. This indicates that each of the polymeric corrosion inhibitors functions effectively at a time of 24 hours and a temperature of 200° F. Additionally, fluids #7, 10, and 12 exhibited excellent corrosion weight loss and corrosion rate values at a time of 7 days. This indicates that the polymeric corrosion inhibitors, when used in conjunction with a corrosion inhibitor intensifier, function effectively as a corrosion inhibitor at a time of 7 days and a temperature of 200° F. Summarily, the addition of a corrosion inhibitor intensifier and its concentration may need to be adjusted depending on the anticipated bottomhole temperature of the well and the length of time of use of the treatment fluid.

Table 3 illustrates fluids that simulate wellbores containing a filtercake. The metal plates were tested by preparing the test fluids as follows: deionized water; sodium chloride salt at a concentration of 9.2 pounds per gallon (ppg) of the water; and a formate ester-based delayed acid breaker system at a concentration of 10% by volume of the water were added to a mixing container and the delayed acid was allowed to hydrolyze in the salt water for 16 hours. The following ingredients were then added to the test fluids: BARACARB® containing calcium carbonate to simulate a filtercake at a concentration of 20 grams (g); HII-124B™ corrosion inhibitor intensifier at a concentration of 120 pounds per 1,000 gallons (lb/1,000 gal) of the treatment fluid; and a polymeric corrosion inhibitor at a concentration of 1% by volume of the water (% vl). Table 3 contains type of corrosion inhibitor, final pH, corrosion weight loss (lb/sq. ft.), and corrosion rate data (mpy) for the treatment fluids at a time of 7 days and a temperature of 200° F. (93° C.).

TABLE 3

| | | | | Corrosion |
|---|---|---|---|---|
| Fluid | | Final | Weight Loss | Rate |
| # | Type of Corrosion Inhibitor | pH | (lb/sq. ft.) | (mpy) |
| 1 | POLY SUGA ®QUAT S1010P | 4.98 | 0.0272 | 34.76 |
| 2 | CRODACEL ™ QM-LQ-(WD) | 4.96 | 0.0217 | 27.74 |

As can be seen in Table 3, the treatment fluids had a corrosion weight loss of less than 0.05 lb/sq. ft. and a corrosion rate of less than 50 mpy. Moreover, the data in Table 3 indicates that when actual wellbore conditions are simulated, the delayed acid breaker system functions effectively and the corrosion inhibitor also functions effectively.

Table 4 contains the type of corrosion inhibitor, the concentration of the corrosion inhibitor in milligrams (mg), and the percent biodegradability results for the corrosion inhibitors at a time of 28 days when tested according to the OECD 306 biodegradability test.

TABLE 4

| | Corrosion | |
|---|---|---|
| Type of Corrosion Inhibitor | Inhibitor (mg) | Biodegradability |
| POLY SUGA ®QUAT S1010P | 1.0 | 60.2% |
| CRODACEL ™ QM-LQ-(WD) | 5.0 | 71.7% |

As can be seen in Table 4, both of the polymeric corrosion inhibitors had a biodegradability of greater than 60%. This means that the corrosion inhibitors can be classified as both primary and ultimate biodegradable. Moreover, both of the corrosion inhibitors are environmentally-friendly. Both of the polymers have a molecular weight of greater than 700 which means that according to the OSPAR regulations, the polymers are non-bioaccumulative. Bioaccumulation refers to the accumulation of toxic substances, such as pesticides, or other organic chemicals in an organism in which the organism absorbs the toxic substance at a rate greater than that at which the substance is lost from the organism.

The exemplary fluids and additives disclosed herein may directly or indirectly affect one or more components or pieces of equipment associated with the preparation, delivery, recapture, recycling, reuse, and/or disposal of the disclosed fluids and additives. For example, the disclosed fluids and additives may directly or indirectly affect one or more mixers, related mixing equipment, mud pits, storage facilities or units, fluid separators, heat exchangers, sensors, gauges, pumps, compressors, and the like used generate, store, monitor, regulate, and/or recondition the exemplary fluids and additives. The disclosed fluids and additives may also directly or indirectly affect any transport or delivery equipment used to convey the fluids and additives to a well site or downhole such as, for example, any transport vessels, conduits, pipelines, trucks, tubulars, and/or pipes used to fluidically move the fluids and additives from one location to another, any pumps, compressors, or motors (e.g., topside or downhole) used to drive the fluids and additives into motion, any valves or related joints used to regulate the pressure or flow rate of the fluids, and any sensors (i.e., pressure and temperature), gauges, and/or combinations thereof, and the like. The disclosed fluids and additives may also directly or indirectly affect the various downhole equipment and tools that may come into contact with the fluids and additives such as, but not limited to, drill string, coiled tubing, drill pipe, drill collars, mud motors, downhole motors and/or pumps, floats, MWD/LWD tools and related telemetry equipment, drill bits (including roller cone, PDC, natural diamond, hole openers, reamers, and coring bits), sensors or distributed sensors, downhole heat exchangers, valves and corresponding actuation devices, tool seals, packers and other wellbore isolation devices or components, and the like.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is, therefore, evident that the particular illustrative embodiments disclosed above may be altered or modified and all such variations are considered within the scope and spirit of the present invention. While compositions and methods are described in terms of “comprising,” “containing,” or “including” various components or steps, the compositions and methods also can “consist essentially of” or “consist of” the various components and steps. Whenever a numerical range with a lower limit and an upper limit is disclosed, any number and any included range falling within the range is specifically disclosed. In particular, every range of values (of the form, “from about a to about b,” or, equivalently, “from approximately a to b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

1. A method of treating a portion of a well comprising:
forming a treatment fluid, wherein the treatment fluid comprises:
(A) water;
(B) a carboxylate, wherein the carboxylate is part of a delayed acid breaker system; and
(C) a corrosion inhibitor, wherein the corrosion inhibitor is environmentally-friendly, biodegradable, and is a polymer, wherein the polymer comprises a carbohydrate backbone and a quaternary amine functional group, and wherein the polymer has a molecular weight such that the polymer is biodegradable;
wherein a test fluid consisting essentially of the water, the carboxylate, and the corrosion inhibitor, and in the same proportions as in the treatment fluid, is capable of providing a corrosion weight loss to a metal plate of less than 0.05 pounds per square feet (lb/ft²) under testing conditions of 200° F. (93.3° C.), a pressure of 500 psi (3.4 MPa), and a time of 24 hours whereas a substantially identical test fluid without the corrosion inhibitor provides a corrosion weight loss of greater than 0.05 lb/ft² under the testing conditions; and
introducing the treatment fluid into the well.

2. The method according to claim 1, wherein the water is selected from the group consisting of freshwater, seawater, brine, and any combination thereof in any proportion.

3. The method according to claim 1, wherein the carboxylate is a carboxylate salt.

4. The method according to claim 1, wherein the carboxylate is a carboxylate ester.

5. (canceled)

6. The method according to claim 1, wherein the carboxylate forms a carboxylic acid in the presence of the water.

7. The method according to claim 6, wherein the formation of the carboxylic acid occurs via hydrolysis of the carboxylate and water.

8. The method according to claim 6, wherein the formation of the carboxylic acid is delayed for a desirable amount of time.

9. The method according to claim 8, wherein the desired amount of time is at least the necessary time to introduce the treatment fluid into the well.

10. The method according to claim 6, wherein the carboxylic acid dissolves at least a portion of a filtercake.

11. The method according to claim 10, wherein the carboxylate is in a sufficient concentration such that the hydrolyzed carboxylate dissolves at least a portion of the filtercake.

12. The method according to claim 1, wherein the carboxylate is in a concentration in the range of about 5% to about 25% by weight of the water in the treatment fluid.

13. The method according to claim 1, wherein the polymer is a cationic surfactant.

14. The method according to claim 1, wherein the carbohydrate is a sugar.

15. The method according to claim 1, wherein the carbohydrate is cellulose.

16. The method according to claim 6, wherein the quaternary amine functional group forms a film on a metal surface.

17. The method according to claim 1, wherein the corrosion inhibitor is in at least a sufficient concentration such that the test fluid provides a corrosion weight loss to the metal plate of less than 0.05 lb/ft² under the testing conditions.

18. The method according to claim 1, wherein the number of quaternary amine functional groups of the polymer is at least a sufficient number such that the test fluid provides a corrosion weight loss to the metal plate of less than 0.05 lb/ft² under the testing conditions.

19. The method according to claim 1, wherein the corrosion inhibitor is in a concentration in the range of about 0.5% to about 5% by volume of the water.

20. The method according to claim 1, wherein the treatment fluid further comprises a corrosion inhibitor intensifier.

21. The method according to claim 1, wherein the treatment fluid is a drilling fluid, spacer fluid, completion fluid, a work-over fluid, a stimulation fluid, or a packer fluid.

22. The method according to claim 1, wherein the corrosion inhibitor polymer is non-bioaccumulative.

23. A method of treating a portion of a well comprising:
forming a treatment fluid, wherein the treatment fluid comprises:
(A) water;
(B) a carboxylate, wherein the carboxylate is capable of forming a carboxylic acid in the presence of the water; and
(C) a corrosion inhibitor, wherein the corrosion inhibitor:
(i) is environmentally-friendly and biodegradable; and
(ii) is a polymer, wherein the polymer comprises a carbohydrate backbone and a quaternary amine functional group, and wherein the polymer has a molecular weight such that the polymer is biodegradable; and
introducing the treatment fluid into the well.

24. A treatment fluid comprising:
water;
a carboxylate; and
a corrosion inhibitor, wherein the corrosion inhibitor is environmentally-friendly, biodegradable, and is a polymer, wherein the polymer comprises a carbohydrate backbone and a quaternary amine functional group;
wherein a test fluid consisting essentially of the water, the carboxylate, and the corrosion inhibitor, and in the same proportions as in the treatment fluid, is capable of providing a corrosion weight loss to a metal plate of less than 0.05 pounds per square feet (lb/ft²) under testing conditions of 200° F. (93.3° C.), a pressure of 500 psi (3.4 MPa), and a time of 24 hours whereas a substantially identical test fluid without the corrosion inhibitor provides a corrosion weight loss of greater than 0.05 lb/ft² under the testing conditions.
